(19) United States
(12) Patent Application Publication
(10) Pub. No.: US 2003/0125857 A1
(43) Pub. Date: Jul. 3, 2003

(54) Continuously variable semi-active suspension system using centrally located yaw rate and accelerometer sensors

(75) Inventors: Dinu P. Madau, Dearborn, MI (US); Boris L. Khaykin, West Bloomfield, MI (US)

Correspondence Address: Michael P. Chu, BRINKS HOFER GILSON & LIONE, P.O. Box 10395, Chicago, IL, 60610, US

(73) Assignee: Visteon Global Technologies, Inc.

(21) Appl. No.: 10/040,798

(22) Filed: Dec. 28, 2001

(51) Int. Cl. B60G 17/015

(52) U.S. Cl. 701/37; 701/38; 280/5.507

(57) ABSTRACT

An apparatus for a continuously variable semi-active suspension system using centrally located yaw rate and accelerometer sensors. The yaw rate sensors measure both pitch and roll. The vertical accelerometers measure bounce. Locating the sensors near the center not only centralizes the sensors, reducing wiring, but also reduces noise and simplifies calculations by not having to project measurements to the center of gravity.

### FIELD OF THE INVENTION

The present invention relates to vehicle suspension systems, and in particular to an apparatus and method of controlling continuously variable semi-active suspension systems using a centrally located sensor package.

### BACKGROUND OF THE INVENTION

A vehicle suspension is an important factor in the ride and handling of a vehicle. The suspension controls the relative motion between the unsprung mass of the tire and the sprung mass of the chassis. One type of suspension system is a semi-active system.

Semi-active systems dissipate power by varying the damped resistance to motion. More specifically, semi-active systems select the stiffness of the suspensions. With continuously variable suspensions, semi-active systems can select from a continuous spectrum of stiffnesses, as opposed to the discrete levels of stiffness associated with other suspensions. Semi-active systems do not have the ability to generate forces to control vehicle behavior, but merely adjust damping. As a result, semi-active systems use a low amount of energy. A drawback of current continuously variable semi-active systems is that they require extensive, complex control systems containing multiple, separate sensors to control the damping at each specific wheel.

There are several drawbacks to utilizing sensors throughout the vehicle. One example of a vehicle containing sensors throughout the vehicle contains a suspension control system that uses three accelerometers: two located at the front corners of the vehicle and one located in middle of the rear. The system can also contain a lateral accelerometer located near the center of gravity of the vehicle. The system extrapolates bounce, pitch, and roll acceleration signals to the center of gravity from the accelerometers, then integrates the acceleration signals to obtain the bounce, pitch, and roll velocities at the center of gravity. The proximity of the engine to the front two vertical accelerometers can cause noise in their generated signals, creating inaccuracies. The source of the noise is the vibration of the engine and electrical interference from the components in the engine. Furthermore, because the signals are integrated to obtain the bounce, pitch, and roll velocities, inherit errors arise from the calculation. Sensors also drift due to temperature fluctuations. Typically, other sensors compensate for the drifting sensor. The compensation is know as temperature drift compensation. In prior systems, this compensation was difficult however, because the temperature varied from sensor to sensor due to the distance between them. Therefore, a simpler, more accurate system would benefit the effectiveness of suspension systems.

### BRIEF SUMMARY OF THE INVENTION

In one embodiment of the present invention, a motor vehicle sensor package is provided. The sensor package comprises two yaw rate sensors and at least one vertical accelerometer. The two yaw rate sensors are mounted near the center of gravity of the vehicle to measure yaw along two perpendicular axes. The vertical accelerometer is also positioned near the center of gravity of the vehicle.

In another embodiment of the invention, the sensor package comprises a combination sensor. The sensor measures two yaw rates and a linear acceleration. The sensor is mounted to measure yaw along two perpendicular axes and the vertical acceleration of the vehicle near the center of gravity.

The invention may further be embodied as a sensor package near the center of gravity. The package is comprised of a combination sensor which measures two yaw rates and two linear accelerations. The sensor is mounted to measure a first yaw rate along a first axis and a second yaw rate along an axis which is perpendicular to the first axis. The sensor also measures vertical and lateral acceleration of the vehicle near the center of gravity.

Another embodiment of the invention is a suspension system for a vehicle. The suspension system includes a sensor package near the center of gravity for measuring bounce, pitch, and roll. The embodiment further comprises a controller for receiving the measurements from the sensor package, integrating the bounce acceleration to obtain bounce velocity, calculating damping control and converting these controls into signals. At least one continuously variable damper is provided for receiving signals from the controller and adjusting damping according to the signal.

The invention may be further embodied as a method for controlling continuously variable semi-active suspension systems in vehicles. The embodiment comprises the steps of measuring bounce, pitch, and roll at the center of gravity of the vehicle, receiving the bounce, pitch, and roll measurements in a controller, integrating bounce acceleration to obtain bounce velocity, and creating control signals based on the bounce, pitch, and roll. The embodiment further comprises the steps of sending the control signals to continuously variable semi-active dampers, and correcting damping according to the control signals.

Other systems, methods, features, and advantages of the invention will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF SEVERAL VIEWS OF THE DRAWINGS

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

FIG. 1 illustrates a plan view of a vehicle incorporating sensors located throughout the vehicle, as well as sensors at the center of gravity of the vehicle;

FIG. 2 illustrates a plan view of a vehicle incorporating a sensor package located near the center of gravity in accordance with the present invention;

FIG. 3 illustrates an orthogonal view of a cross section of a vehicle utilizing an embodiment of a sensor package comprising individual sensors located near the center of gravity in accordance with the present invention;

FIG. 4 illustrates an orthogonal view of a cross section of a vehicle utilizing another embodiment of a sensor package comprising a combination sensor and a lateral accelerometer located near the center of gravity in accordance with the present invention;

FIG. 5 illustrates an orthogonal view of a cross section of a vehicle utilizing another embodiment of a sensor package comprising a combination sensor located near the center of gravity in accordance with the present invention; and

FIG. 6 illustrates a flow diagram detailing the steps of the method according the present invention.

### DETAILED DESCRIPTION OF THE PRESENTLY PREFERRED EMBODIMENTS

The present invention provides an exemplary embodiment of an apparatus and a method for obtaining bounce, pitch, and roll measurements from a sensor package located near the center of gravity. These signals are used to generate bounce, pitch, and roll control signals. The embodiment not only simplifies the state of the art by centralizing all the sensors in one place, but it also reduces sensor noise typically associated with sensors located near the engine of the vehicle. Furthermore, the embodiment simplifies the compensation for sensor drift due to temperature. Finally, the sensor package near the center of gravity simplifies the calculations required to obtain the bounce, pitch, and roll control signals.

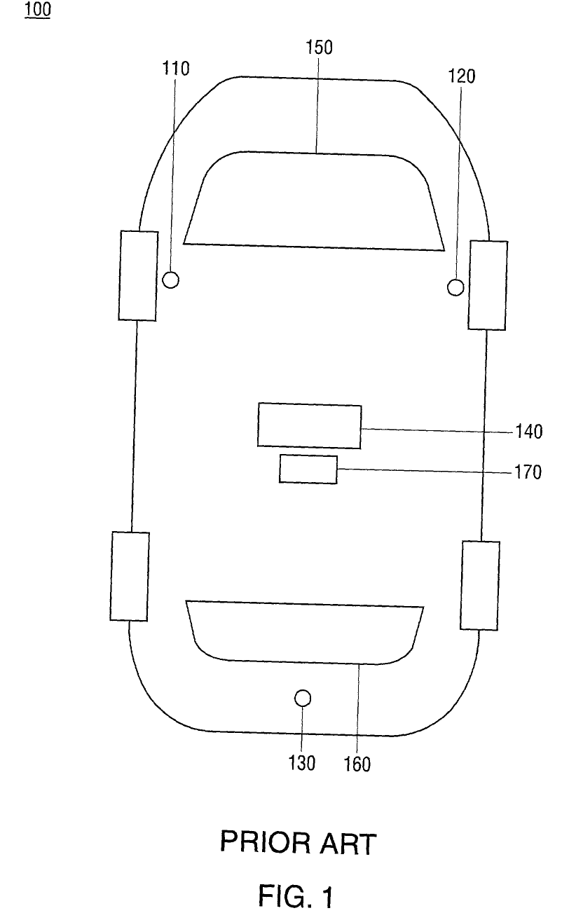

FIG. 1 displays an overhead schematic view of a vehicle containing sensors located throughout the vehicle 110, 120, 130 as well as a sensor package near the center of gravity 140. In former designs, vehicles have three accelerometers, one near each front wheel 110, 120, and one near the center of the rear 130. These accelerometers are wired to a controller 170 which receives the signals from the accelerometers, and extrapolates bounce, pitch, and roll to the center of gravity.

Several shortcomings are inherent to this design. First, the distances between the accelerometers 110, 120, 130 and the controller 170 demand large amounts of wiring. This wiring is susceptible to failure due to such events as shorts or loose connections. Second, the accelerometers 110, 120, 130 experience noise. The front accelerometers 110, 120 experience noise from a front engine 150 in a front engine design. Conversely, the rear accelerometer 130 experiences noise from a rear engine 160 in a rear engine design. Furthermore, the calculation from the signals from the accelerators contain inherent errors. The signals from the accelerometers not only need to be projected to the center of gravity of the vehicle, but must also be integrated to obtain the rates. Finally, temperature drift compensation was difficult because the distance between sensors allowed for different temperatures in individual sensors. A sensor package near the center of gravity of the vehicle 140 remedies these shortcomings.

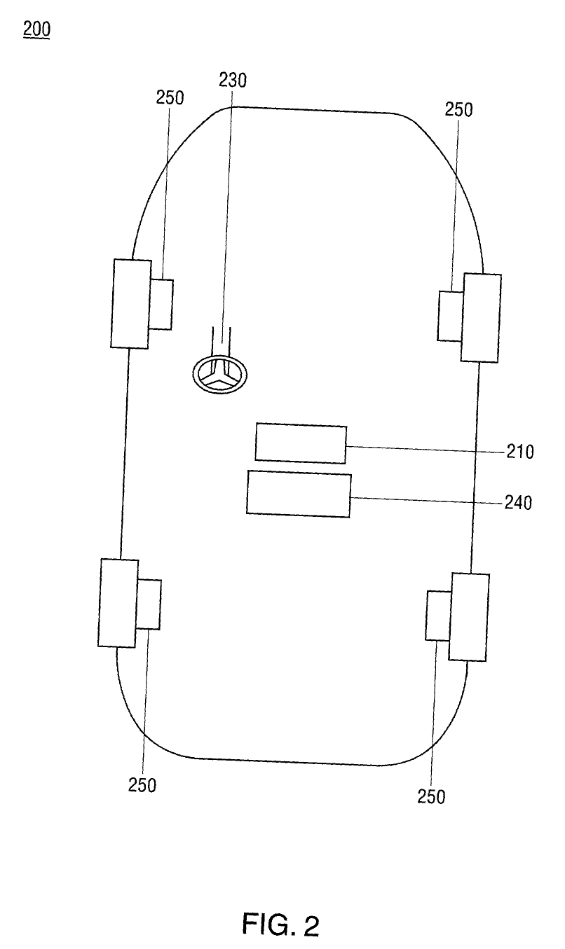

FIG. 2 displays an overhead schematic view of a vehicle 200 containing a sensor package 210 located near the center of gravity of the vehicle in accordance with a preferred embodiment of the invention. With reference to FIG. 2, a controller means 240 reads bounce acceleration, pitch velocity, and roll velocity measurements, as well as a lateral acceleration measurement from the sensor package 210 near the center of gravity of the vehicle. The controller means can be a microprocessor, microcomputer, or the like. Furthermore, the controller means 240 can read a measurement from a steering wheel angle sensor 230. The lateral acceleration measurement and the steering wheel angle measurement are not necessary for the ride performance of the suspension, but are useful in improving the handling of the vehicle. The controller means 240 can then integrate the bounce acceleration to obtain a bounce velocity and apply an algorithm based on the bounce, pitch, and roll measurements and develop individual control signals for each damper 250. The controller means 240 then sends the signals to the individual dampers 250 to modify the respective damping properties of each damper.

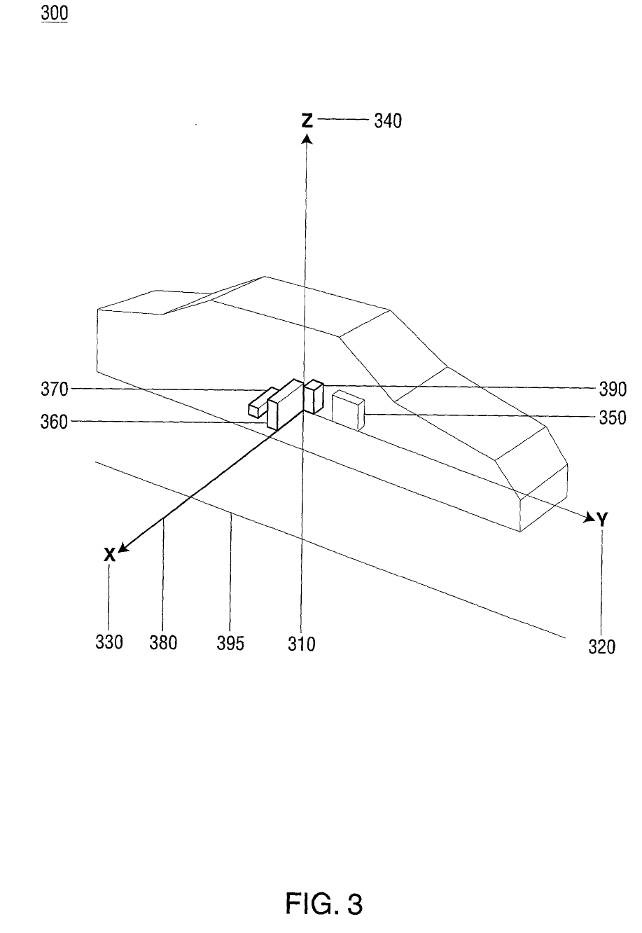

FIG. 3 represents a cross-section of a vehicle 300 with an axis superimposed over the vehicle 300. The origin of the axis is at the center of gravity 310 of the vehicle 300 if the vehicle was whole. FIG. 3 also contains the sensors that constitute the center of gravity sensor package 210 (FIG. 2). The sensor package 210 (FIG. 2) comprises two similar yaw sensors 350, 360. Yaw is the turning rate about an axis. The sensors 350, 360 are positioned to measure the yaw perpendicular to the road 395. The yaw rate sensors 350, 360 are preferably positioned so that their axis of measurement are perpendicular to each other. One yaw rate sensor 350 is aligned on the Y axis 320 and measures the pitch of the vehicle 300. The pitch is the tilting displacement of the of the vehicle 300 around the latitudinal, or X axis 330. The other yaw rate sensor 360 is aligned along the X axis 330. This positioning allows the sensor 360 to measure the roll of the vehicle. The roll of the vehicle is the tilting displacement of the vehicle body 300 around its longitudinal, or Y axis 320. A vertical accelerometer 390 is also present near the center of gravity 310. The sensor 390 measures the vertical acceleration, or bounce, along the Z axis 340. The bounce of the vehicle is the acceleration of the vertical displacement of the vehicle 300 at the center of gravity 310. A lateral sensor 370 is also included in the centrally located sensor package 210 (FIG. 2). The lateral accelerometer 370 is not used for suspension ride control, but can be used for improving suspension handling control. The functionality of the lateral accelerometer 370 only requires that it be positioned in relation to the combination yaw rate and accelerometer sensors 350, 360 as to measure lateral, or side-to-side acceleration along the X axis 330.

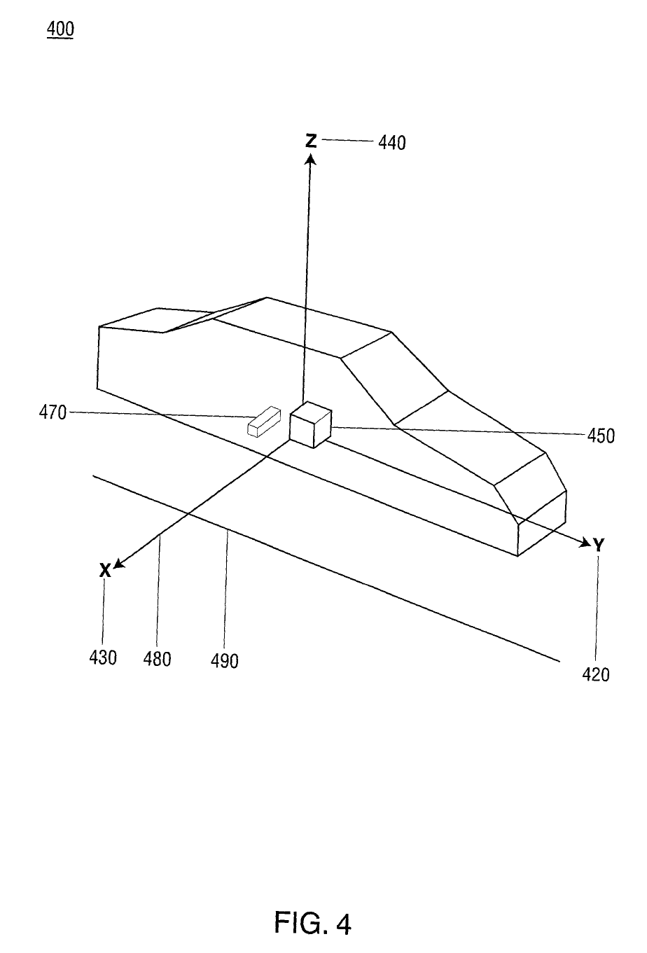

FIG. 4 represents another embodiment of the invention. FIG. 4 displays a cross-section of a vehicle 400 with an axis 480 superimposed over it. The origin of the axis is at the center of gravity of the vehicle if the vehicle was whole. In FIG. 4, the sensor package 210 (FIG. 2) comprises a combination sensor which measures two yaw rates and a linear acceleration. This position allows the sensor to measure the two yaws perpendicular to the road 490 and the vertical acceleration near the center of gravity. The sensor is positioned to measure the yaw along the Y axis 420. This measurement is the pitch of the vehicle. The combination sensor 450 is further aligned to measure a second yaw along the X axis 430, allowing the sensor 450 to measure the roll of the vehicle. The sensor 450 also measures the bounce along the Z axis 440. A lateral sensor 470 is also present near the center of gravity. As previously mentioned, the lateral accelerometer 470 is not used for suspension ride control, but can be used for improving handling control. The lateral accelerometer 470 is positioned in relation to the combination sensor 450 so as to measure lateral acceleration along the X axis 430.

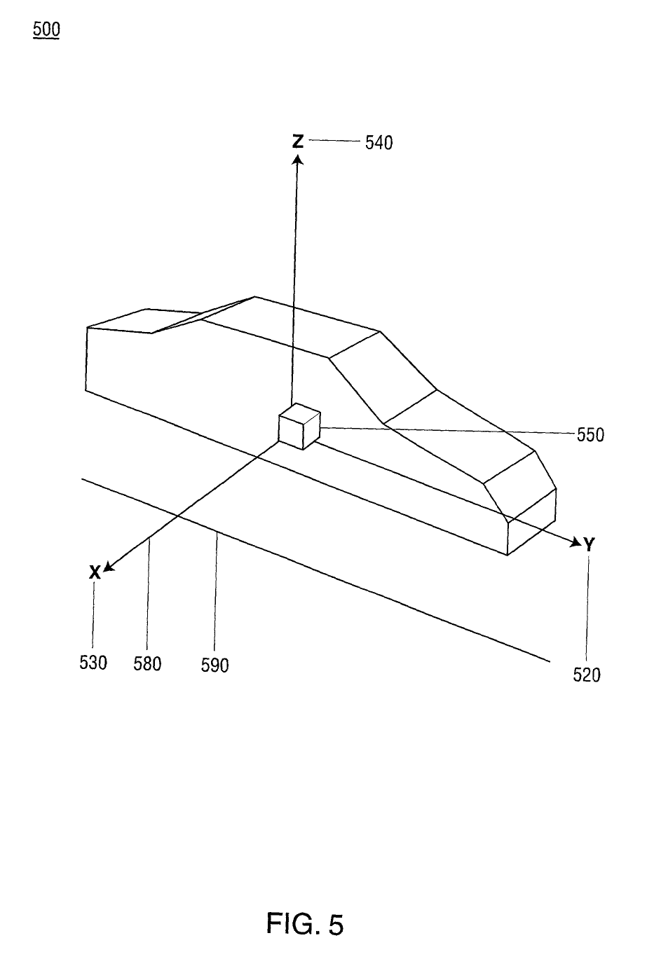

FIG. 5 demonstrates another embodiment of the invention. FIG. 5 displays a cross section of a vehicle 500 with an axis 580 superimposed over it. Like FIGS. 3 and 4, the origin of the axis is located at the center of gravity of the vehicle if the vehicle was whole. FIG. 5 contains a sensor package at the center of gravity of the vehicle. The sensor package is a combination sensor 550. The combination sensor 550 measures two yaw rates and two linear accelerations. The combination sensor 550 is mounted to measure the two yaw rates perpendicular to the road 590, the vertical acceleration near the center of gravity, and the lateral acceleration near the center of gravity. The combination sensor 550 is mounted to measure one yaw rate along the Y axis 520. This yaw rate is the pitch. The mounting further allows the sensor 550 to measure yaw rate along the X axis 530. This yaw rate is the roll. The combination sensor 550 also measures acceleration along the Z axis 540. This measurement is the bounce. Finally, the combination sensor measures the lateral acceleration along the X axis 530.

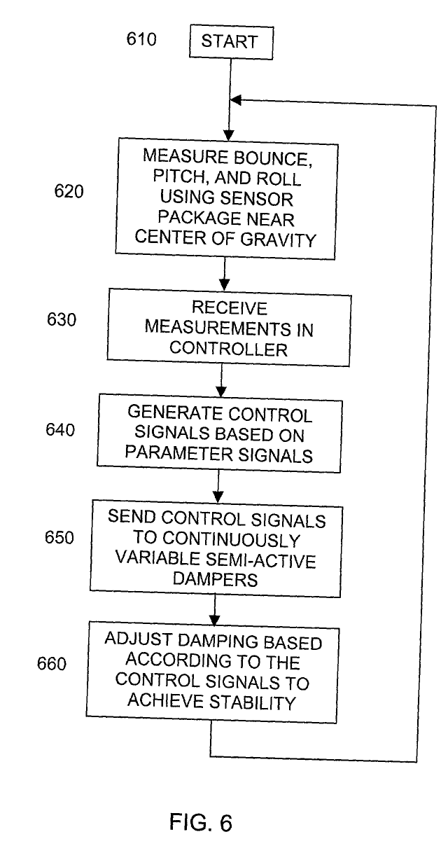

This FIG. 6 reflects another embodiment of the invention. This embodiment illustrates a method of using a sensor package near the center of gravity to provide the input necessary to control a continuously variable semi-active suspension system. In FIG. 6, the system begins with no information regarding the bounce, pitch, or roll 610. The bounce acceleration, pitch velocity, and roll velocity are then measured by the sensor package near the center of gravity of the vehicle 620. These measurements are read by the controller 630. The controller 630 can be a microprocessor, microcomputer, or the like. The controller 630 integrates the bounce acceleration to obtain a bounce velocity, and then generates control signals based on the bounce, pitch, and roll signals to ensure or improve the ride and handling performance of the vehicle 640. These control signals are sent to the continuously variable semi-active dampers 250 (FIG. 2) located in the suspension of each wheel 650. The dampers adjust their damping according to the control signals 660. This method is repeated continuously so that ride and handling performance is maximized.

Referring back to FIG. 1, this Figure further exemplifies the theory behind the embodiments of FIGS. 3, 4, 5, and 6. In the embodiments of FIGS. 3, 4 and 5, and 6, the combination of the sensors into a package near the center of gravity of the vehicle 140 removes the need for sensors to be mounted throughout the vehicle, greatly reducing the amount of wiring and reducing the likelihood of failure due to the wiring, such as shorts and loose connections. Furthermore, the sensor package near the center of gravity of the vehicle 140 does not experience as much noise as positioned sensors 110, 120, 130 mounted throughout the vehicle. The lack of noise is attributable to the distance between the center of gravity 140 and a front engine compartment 150 or a rear engine compartment 160. The detection of roll by the sensor package near the center of gravity of the vehicle 140 in the present embodiments also is an improvement over former designs. In former designs, noise made the roll acceleration and rate highly unreliable because the two important sensors for roll 110, 120 were both located near the front engine compartment 450. Reducing the noise by using a sensor package near the center of gravity of the vehicle 140 allows the calculations to be more accurate. In addition, the location of the sensor package away from the distant points of the vehicle reduces error from other movement factors, such as wheel vibration, flexing and other factors. Furthermore, measuring yaw rate by the sensor package near the center of gravity 140 simplifies calculations. First, the location of the sensors removes the need to extrapolate measurements to the center of gravity because the measurements are initially at the center of gravity. The location also removes the need to integrate the signals the differences in signal pairs from the accelerometers 110, 120, 130 to obtain the pitch and roll rates required for control calculations, thus significantly reducing or removing any error that is introduced by the calculation and noise. Finally, positioning all the sensors together simplifies temperature drift compensation. By locating the sensors together, the temperature of the sensors are likely to be similar. Similar sensor temperatures reduce the error when one sensor compensates for the temperature drift of another sensor.

Various embodiments of the invention have been described and illustrated. However, the description and illustrations are by way of example only. Many more embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. A vehicle motion sensor package comprising:
a first yaw rate sensor mounted near the center of gravity of a vehicle to measure a first yaw along a first axis;
a second yaw rate sensor mounted near the center of gravity of said vehicle to measure a second yaw along a second axis perpendicular to said first axis; and
at least one accelerometer mounted adjacent to said first yaw rate sensor and said second yaw rate sensor.

2. The vehicle motion sensor package of claim 1 wherein:
said first yaw rate sensor is so mounted as to measure pitch velocity of said vehicle;
said second yaw rate is mounted as to measure roll velocity of said vehicle; and
said at least one accelerometer is so mounted as to measure vertical bounce acceleration of said vehicle.

3. The vehicle motion sensor package of claim 1 further comprising a lateral accelerometer sensor mounted within the package and in proximity to said first and second yaw rate sensor to measure lateral acceleration of said vehicle.

4. A vehicle motion sensor package comprising a combination sensor measuring two yaws and a linear acceleration, wherein said combination sensor is mounted near the center of gravity of a vehicle to measure a first yaw along a first axis, a second yaw along a second axis perpendicular to said first axis, and a vertical acceleration near the center of gravity.

5. The vehicle motion sensor package of claim 4 wherein said combination sensor is mounted as to measure bounce, pitch, and roll of said vehicle.

6. The vehicle motion sensor package of claim 4 further comprising a lateral accelerometer sensor within the package and in proximity to said combination sensor to measure lateral acceleration of said vehicle.

7. A vehicle motion sensor package comprising a combination sensor measuring two yaws, and two linear accelerations wherein said combination sensor is mounted near the center of a vehicle to measure a first yaw along a first axis, a second yaw along a second axis perpendicular to said first axis, a vertical acceleration, and a lateral acceleration.

8. The vehicle motion sensor package of claim 7 wherein said combination sensor is mounted to measure bounce, pitch, roll, and lateral acceleration of said vehicle.

9. A suspension system for a vehicle comprising:
a sensor package located near the center of gravity of a vehicle for measuring bounce acceleration, pitch velocity, and roll velocity and converting the measurements into signals;
a controller means in communication with said sensor package for receiving said signals from said sensor package, integrating bounce acceleration to obtain bounce velocity, calculating damping controls necessary to maintain desired ride and handling performance, and converting said damping control into at least one damping control signal; and
at least one continuously variable damper mounted remotely from said sensor package in communication with said controller means for receiving said at least one damping control signal and adjusting damping according to said at least one damping control signal in order to achieve desired ride and handling performance.

10. The suspension system in claim 9, wherein said sensor package further measures lateral acceleration and said controller reads lateral acceleration signals from the said sensor package.

11. The suspension system of claim 9, wherein said sensor package further comprises:
a first yaw rate sensor mounted near the center of gravity of the vehicle to measure yaw along a first axis;
a second yaw rate sensor near said first yaw rate sensor to measure yaw along a second axis perpendicular to said first axis; and
at least one accelerometer located adjacent to said first yaw rate sensor and said second yaw rate sensor.

12. The suspension system of claim 9, wherein said first yaw rate sensor is mounted to measure pitch of said vehicle, said second yaw rate is mounted to measure roll of said vehicle, and said at least one accelerometer is mounted to measure bounce of said vehicle.

13. The suspension system of claim 9, wherein said sensor package further comprises a combination yaw rate and accelerometer sensor measuring two yaw rates and an acceleration mounted to measure a first yaw rate along a first axis, a second yaw rate along a second axis perpendicular to said first axis and a vertical acceleration near the center of gravity.

14. The suspension system of claim 9 wherein said sensor package further comprises a combination yaw rate and accelerometer sensor measuring two yaw rates and two accelerations mounted to measure a first yaw rate along a first axis, a second yaw rate along a second axis perpendicular to said first axis, a vertical acceleration near the center of gravity, and a lateral acceleration.

15. A method for controlling a continuously variable semi-active suspension system in vehicles comprising the steps of:
measuring bounce acceleration, pitch velocity, and roll velocity near the center of gravity of the vehicle using a sensor package;
reading said bounce acceleration, pitch velocity, and roll velocity measurements by a controller;
integrating said bounce acceleration to obtain bounce rate;
generating control signals in said controller based on said bounce, pitch, and roll measurements;
sending said control signals from said controller to continuously variable semi-active dampers positioned in said suspension system of the vehicle; and
adjusting damping of said suspension system based on the control signals by said continuously variable semi-active dampers to achieve desired ride and handling performance.

16. The method of claim 15, wherein said sensor package further comprises:
a first yaw rate sensor mounted near the center of gravity of the vehicle to measure yaw along a first axis;
a second yaw rate sensor mounted near the center of gravity of the vehicle to measure yaw along a second axis perpendicular to said first axis; and
at least one vertical accelerometer located adjacent to said first yaw rate sensor and said second yaw rate sensor.

17. The method of claim 16 wherein said sensor package further comprises at least one lateral accelerometer located adjacent to said first yaw rate sensor, said second yaw rate sensor, and said at least one vertical accelerometer.

18. The method of claim 16, wherein:
said first yaw rate sensor measure pitch;
said second yaw rate sensor measures roll; and
said at least one vertical accelerometer measures bounce.

19. The method of claim 15, wherein said sensor package further comprises a combination sensor measuring two yaws and a linear acceleration, wherein said combination sensor is mounted near the center of gravity of a vehicle to measure a first yaw rate along a first axis, a second yaw along a second axis perpendicular to said first axis, and a vertical acceleration.

20. The method of claim 19, wherein said sensor package further comprises a lateral accelerometer located adjacent to said combination sensor.

21. The method of claim 15 wherein said sensor package further comprises a combination sensor measuring two yaws and two linear accelerations, wherein said combination sensor is mounted near the center of gravity of a vehicle to measure a first yaw rate along a first axis, a second yaw rate along a second axis perpendicular to said first axis, a vertical acceleration, and a lateral acceleration.
